(19) United States
(12) Patent Application Publication
(10) Pub. No.: US 2009/0016355 A1
(43) Pub. Date: Jan. 15, 2009

(54) COMMUNICATION NETWORK INITIALIZATION USING GRAPH ISOMORPHISM

(76) Inventor: William A. Moyes, Austin, TX (US)

Correspondence Address: ZAGORIN O'BRIEN GRAHAM LLP, 7600B NORTH CAPITAL OF TEXAS HIGHWAY, SUITE 350, AUSTIN, TX, 78731, US

(21) Appl. No.: 11/777,727

(22) Filed: Jul. 13, 2007

(51) Int. Cl. H04L 12/56

(52) U.S. Cl. 370/395.31

(57) ABSTRACT

A communication system, such as a computer system, with a plurality of processing nodes coupled by communication links stores a database of abstract topologies that provides a node adjacency matrix and abstract routing between nodes. A breadth-first discovery of the actual communication fabric is performed starting from an arbitrary root node to discover the actual topography. A graph isomorphism algorithm finds a match between the discovered topology and one of the stored abstract topologies. The graph isomorphism algorithm provides a mapping between the ‘abstract’ node numbers and the discovered node numbers. That mapping may be used to rework the stored routing tables into the specific format needed. The computed routing tables are loaded into the fabric starting at the leaf nodes, working back towards the root node (i.e., start loading from the highest node number and work back to the lowest numbered node).

### BACKGROUND

1. Field of the Invention

This invention relates to communication networks and more particularly to initialization of communication networks.

2. Description of the Related Art

In communication systems such as found in multiprocessor computer systems, individual processors and peripheral devices are coupled via communication links. The links are typically packetized point to point connections that allow high speed data transfer between devices resulting in high throughput. More generally, the communication network has a number of nodes (e.g., the processors) connected by links. Network topology refers to the specific configuration of nodes and links forming the communication system.

In a typical link, address, data and commands are sent along the same wires using information ‘packets’. The information packets contain device information to identify the source and destination of the packet. Each device (e.g., processor) in the computer system refers to a routing table to determine the routing of a packet. When a first device or node (e.g., a processor) receives a packet, the first device determines whether the packet is for the first device itself or for some other device in the system. If the packet is for the first device itself, the first device processes the packet. If the packet is destined for another device, the first device determines the appropriate routing by looking up routing of the packet in routing tables and determines which link to use to forward the packet to its destination and forwards the packet on an appropriate link. Note that the device to whom the packet is sent may then consume the packet that is for that device or forward the packet according to its routing tables.

The nodes include internal buffers that temporarily store packets that need to be forwarded to another node. It is possible for situations to arise in which the receive buffers in the node to receive the packet are full so the forwarding node cannot forward the packet. That can result in network congestion, or in extreme cases, even deadlock. Thus, communication networks can enter deadlock states under certain conditions resulting in system failure.

The communication links are typically configured during system initialization. In computer systems, the initialization software (e.g., BIOS) configures the computer system during boot-up process. As part of configuring the computer system, the communications network needs to be configured, which includes setting up the appropriate routing tables. The need to avoid deadlock conditions in multi-processor systems has lead to initialization of the communication network (or fabric) using hardcoded tables for routing that are guaranteed to avoid deadlock. Thus, fabric initialization code in multi-processor (MP) systems requires the manufacturer to describe every communication link in the system ahead of time and then only supports removing processors in order. This reduces the flexibility manufacturers have in configuring the topology of their system. More flexible approaches, such as run-time computation of routing tables at boot-time, is not utilized in the constrained environment of BIOS. Accordingly, a more flexible approach to configuring communication systems would be desirable to allow more flexibility in topologies.

### SUMMARY

A communication system, such as used in a computer system with a plurality of processing nodes coupled by communication links, stores a database of abstract topologies. A breadth-first discovery of the actual communication fabric is performed starting from an arbitrary root node. A graph isomorphism algorithm finds a match between the discovered topology and one of the stored abstract topologies. The graph isomorphism algorithm provides a mapping between the ‘abstract’ node numbers and the real node numbers. That mapping can be used to rework the stored routing tables into the specific format needed using of link numbers found during the discovery. The computed routing tables are loaded into the fabric starting at the leaf nodes, working back towards the root node (i.e. start loading from the highest node number and work back to the lowest numbered node). That ensures that the fabric will not enter an inconsistent state during the routing table update.

In an embodiment a method is provided for initializing a communication system having a plurality of nodes and a plurality of links connecting the nodes. The method includes determining a match between a discovered topology in the communication system and one of a plurality of stored abstract topologies. The method further includes computing routing tables for each of the nodes using the one of the plurality of stored abstract topologies and real node numbers in the discovered topology and loading respective ones of the computed routing tables into the nodes.

In another embodiment a communication system is provided, e.g., as part of a computer system, that includes a plurality of nodes (e.g., processor nodes), and a plurality of communication links coupling the nodes. A storage stores a plurality of abstract topologies of communication links. The system is operable to determine a match between a discovered topology in the system and one of the stored abstract topologies.

The computer system may be further operable to compute routing tables for each of the processing nodes using the one of the stored abstract topologies and the discovered topology and load respective ones of the computed routing tables into the nodes starting at leaf nodes, working back towards a root node.

Still another embodiment provides a computer program product encoded in one or more machine-readable media. The computer program product includes initialization code for initializing a communication system having a plurality of nodes and a plurality of links connecting the nodes. The initialization code is executable to determine a match between a discovered topology in the communication system and one of a plurality of stored abstract topologies and compute routing tables for each of the nodes using the one of the plurality of stored abstract topologies and the discovered topology.

By applying a graph isomorphism algorithm to the problem the initialization software, e.g., BIOS, only needs to contain a small number of generic abstract routing tables that can be mathematically mapped at boot time to fit the current configuration. That concept can be applied to many communication networks. This decreases effort on the part of the original equipment manufacturer (OEM) and improves system flexibility and robustness.

The approach described herein allows end-users to populate central processing units (CPUs) in almost any socket. The approach reduces effort on the part of the OEM when porting the BIOS. If used in a communication network, the approach aids robustness by more easily adapting to link failures. Further, the approach saves space by reducing the number of tables that need to be stored as compared to the hard-coded systems with similar capabilities.

### BRIEF DESCRIPTION OF THE DRAWINGS

The present invention may be better understood, and its numerous objects, features, and advantages made apparent to those skilled in the art by referencing the accompanying drawings.

FIG. 1A illustrates an exemplary multiprocessor computer system 100 implementing an embodiment of the invention.

FIG. 1B illustrates the topology of the example of FIG. 1A in a simpler representation showing only the nodes and the edges.

FIG. 2 illustrates an exemplary processing node of system 100 according to an embodiment of the present invention.

FIG. 3 illustrates overall flow of an embodiment of the invention.

FIGS. 4A-4E illustrate an exemplary discovery process.

FIG. 4F illustrates final routing tables according to an embodiment of the invention.

FIG. 5A and FIG. 5B illustrate different topologies.

FIGS. 6A and 6B illustrate exemplary code that can determine if two graphs are isomorphic utilizing permutations and comparison of adjacency matrixes.

FIG. 7 illustrates a switch incorporating routing tables determined as described herein.

The use of the same reference symbols in different drawings indicates similar or identical items.

### DESCRIPTION OF THE PREFERRED EMBODIMENT(S)

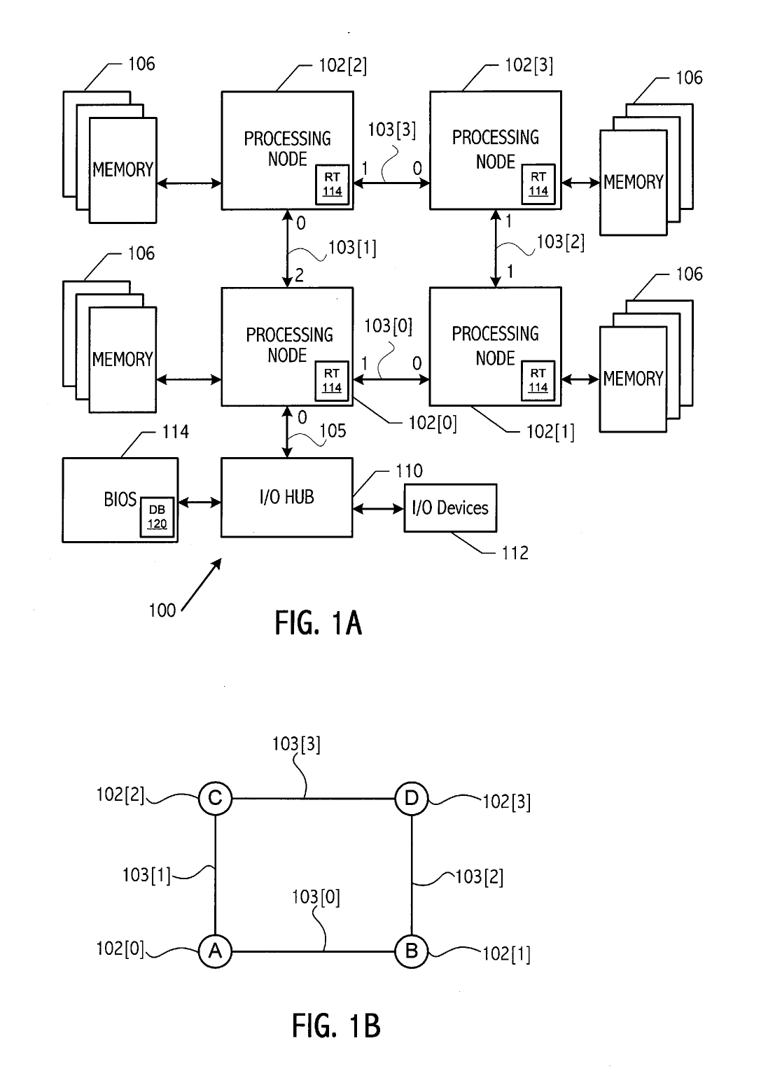

Referring to FIG. 1A an exemplary multiprocessor computer system 100 implementing an embodiment of the invention is illustrated. System 100 is a multiprocessor system with multiple processing nodes 102 (102[0]-102[3]) that communicate with each other via links 103 (103[0]-103[3]). Each of the processing nodes includes a processor, routing tables 114 and additional circuitry not described herein. For purposes of illustration, in the present example, four processing nodes are shown, however one skilled in the art will appreciate that system 100 can include any number of processing nodes connected in different topologies. Links 103 can be any of a number of types of communication links. In the present example, links 103 are dual point to point links according to, for example, a split-transaction bus protocol such as the HyperTransport™ (HT) protocol. Link signals typically include link traffic such as clock, control, command, address and data information and link sideband signals that qualify and synchronize the traffic flowing between devices.

Routing tables (RT) 114 are used by processing nodes 102 to determine the routing of data (e.g., data generated by the node for other processing nodes or received from other nodes). Each processing node communicates with a respective one of memory arrays 106. In the present example, the processing nodes 102 and corresponding memory arrays 106 are in a “coherent” portion of system 100. The coherency refers to the caching of memory, and the HT links between processors are cHT links as the HT protocol includes probe messages for managing the cache protocol. Other (non processor-processor) HT links are ncHT links and may communicate to, e.g., various input/output devices. Thus, the computer system may communicate with various I/O devices 112 via I/O Hub 110 and link 105. In addition, the boot ROM 114 containing the database of abstract topologies 120 may be accessed through the I/O Hub 110. One skilled in the art will appreciate that system 100 can be more complex than shown. For example, additional processing nodes 110 can make up the coherent portion of the system. Additionally, although processing nodes 110 are illustrated in a “ladder architecture,” processing nodes 110 can be interconnected in a variety of ways (e.g., star, mesh, twisted ladder) and can have more complex couplings. FIG. 1B illustrates the topology of the example of FIG. 1A in a simpler representation showing only the nodes and the links.

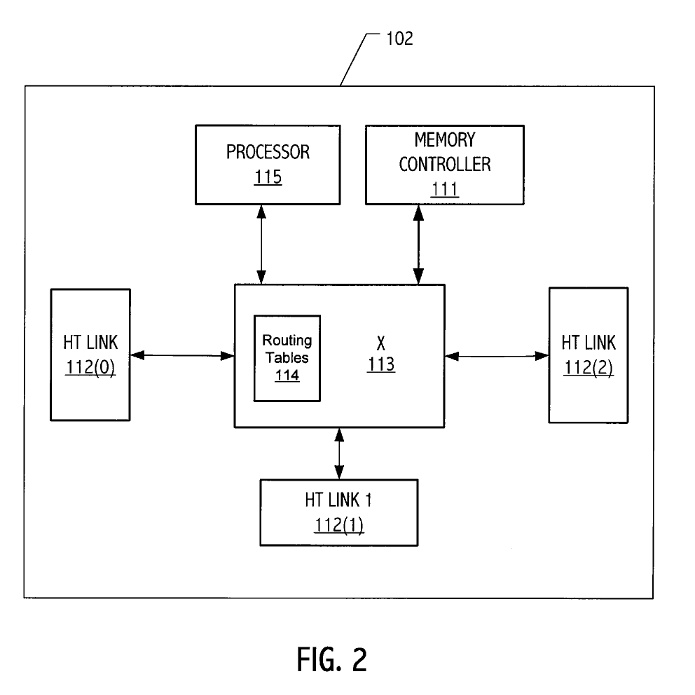

FIG. 2 illustrates an exemplary processing node of system 100 according to an embodiment of the present invention. Processing node 102 includes a processor 115, multiple HT link interfaces 112 (0)-(2) and a memory controller 111. Each HT link interface provides coupling with a corresponding HT link for communication with a device coupled on the HT link. Memory controller 111 provides memory interface and management for corresponding memory array 106 (not shown). A crossbar switch 113 transfers requests, responses and broadcast messages such as received from other processing nodes or generated by processor 115 to the appropriate HT link interface(s) 112. The transfer of requests, responses and broadcast messages is directed by configuration routing tables 114 located in each processing node 102. In the present example, routing tables 114 are included in crossbar 113 however, routing tables 114 can be configured anywhere in the processing node 110 (e.g., in memory, internal storage of the processor, externally addressable database or the like). One skilled in the art will appreciate that processing node 110 can include other processing elements (e.g., redundant HT link interfaces, various peripheral elements needed for processor and memory controller).

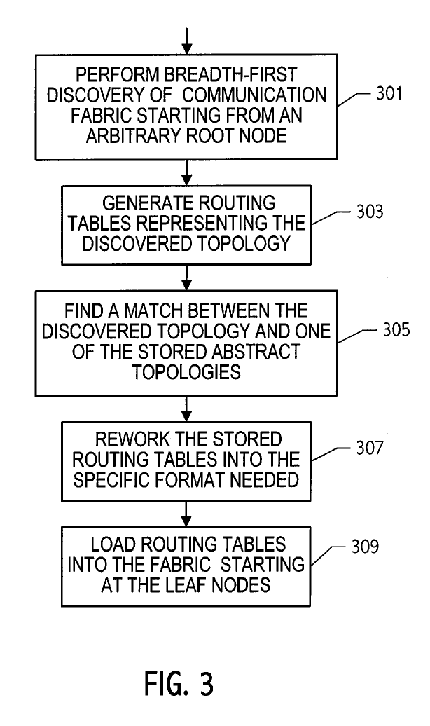

An overall flow of an embodiment of the invention is illustrated in FIG. 3. The computer system, e.g., as part of the basic input/output system (BIOS) code, stores a database of abstract topologies, e.g., in database 120 in memory 114. On boot-up, a breadth-first discovery of the actual communication fabric is performed in 301 starting from an arbitrary root node. The arbitrary root node in an MP environment is typically the bootstrap processor. The arbitrary root node assigns ascending node numbers to each node as it is discovered. The discovery process generates routing tables at 303 representing the discovered topology. A graph isomorphism algorithm finds a match between the discovered topology and one of the stored abstract topologies at 305. The graph isomorphism algorithm provides a mapping between the ‘abstract’ node numbers and the real node numbers. This mapping is used to rework the stored routing tables into the specific format needed at 307. The computed routing tables are loaded into the fabric at 309 starting at the leaf nodes, working back towards the root node (i.e. start loading from the highest node number and work back to node 0). That should guarantee that the fabric will not enter an inconsistent state during the routing table update.

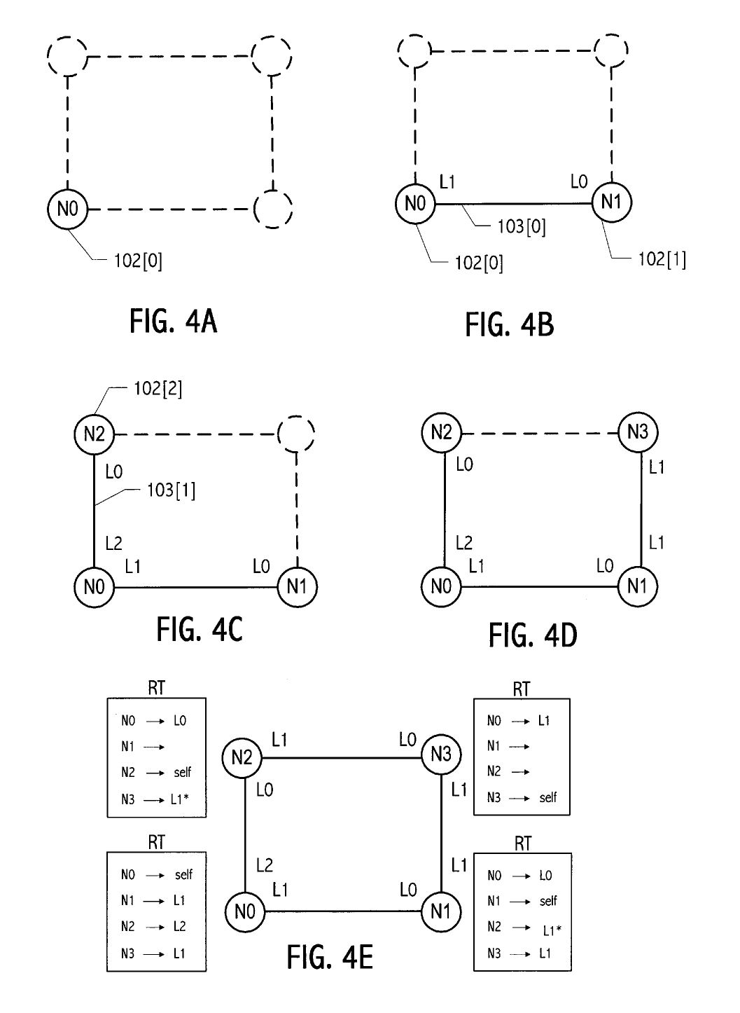

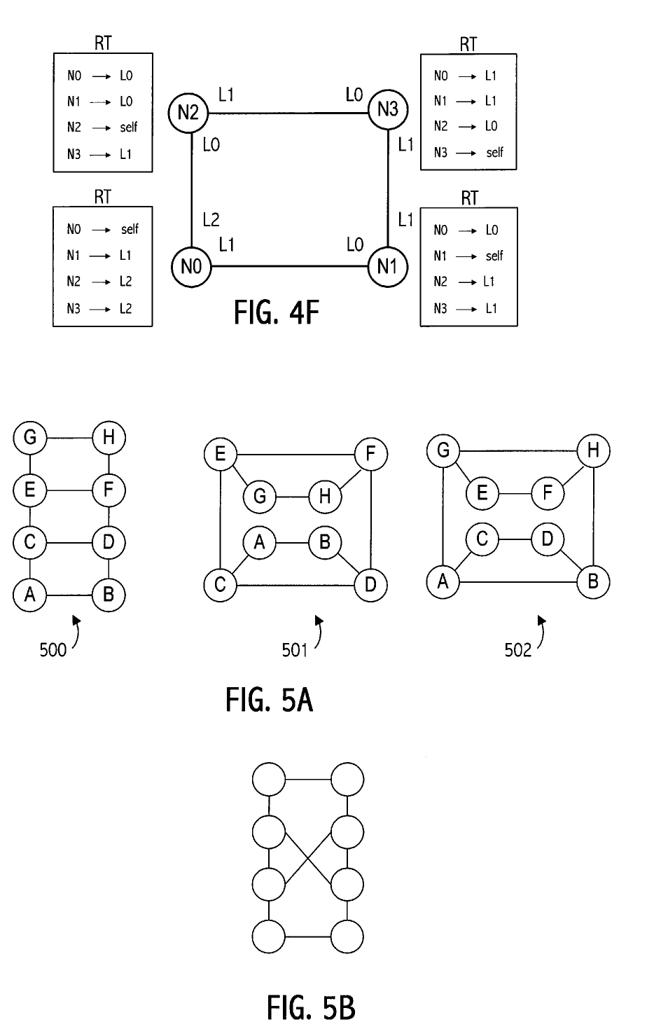

Thus, on boot-up, a breadth-first discovery of the actual communication fabric is performed starting from an arbitrary root node. Referring to FIGS. 4A-4E, and the pseudo-code below, an exemplary discovery process is illustrated.

```
int Discovered = 0;
int Current = 0;
While (Current <= Discovered)
{
    if (Current != 0)
    {
        Set path from BSP to Current
        Set path from BSP to Current for Current+l
        Read DefaultLnk of Current, and set route to BSP =
        DefaultLnk
    }
    Set route to self entry on Current
    Enable routing tables on Current
    for each healthy coherent link not yet explored
    {
        Route from Current to Current+l through selected
        link
        Read token from Current+l
        Read default_link register from Current+1
        if token = default
        {
            Discovered++
            token = Discovered
            Write token back to target Current+l
        }
        Add entry (Current, selected link, Default_Link,
        Token)
    }
    Current++;
}
```

Assuming the arbitrary root node is node 0, the breadth first discovery examines all the links connected to node 0. FIG. 4A shows the undiscovered fabric at the start of the discovery. Note that each node contains a node token that defaults to a predetermined value, e.g., 0. Before routing tables are enabled, the processor is in a special ‘default routing’ mode where all incoming requests are serviced and the responses are sent down the same link on which that the request came. The ‘default link’ is whichever link the request came in on when in ‘default routing’ mode. The CPU contains a register that can be read, the ‘default link register’ which effectively provides the link on which the request to read that register was received. Enabling the routing tables is the signal to switch out of ‘default routing’ mode and into normal operation where the routing tables are used to route the responses back to the requester.

Since on the first pass through the loop, the current node equals 0, the process sets route to self entry on the current node and enables routing tables on the current node. The first link that is not yet explored is link 103[0] connecting node 1 (current +1) to node 0. Note that in FIGS. 4A-4E, the node numbers are indicated as N0 to N3 and the link numbers are indicated by L0, L1, and L2 and match the link numbers shown in FIG. 1. Node 0 sends a message to node 1. In the discovery process node 0 reads the token and the default link from the default_link register of node 1. The default value of the token is 0. Node 0 increments the number of discovered nodes, sets the token to equal the number of discovered nodes, and rewrites the token with a value of 1 to node 1. Then an entry is made (Current, Selected Link, Default_Link, Token) in a data table of discovered links as described further below.

In a breadth first discovery, all the links at a particular node are examined before the links of another node are examined. So referring to FIG. 4C, the next link to be selected is link L1. Again, node 0, after it establishes (routes) a link to node 2, reads the token and the Default_Link register of node 2. The default value of the token is 0. Node 0 increments the number of discovered nodes to 2 and rewrites the token with a value of 2 to node 2. Then an entry is made (Current, Selected Link, Default_Link, Token) in the table of discovered links.

After that, referring to FIG. 4D, with the current node not equal to node zero the breadth first search begins on node 1. As can be seen in the pseudo-code, a path is set from the BSP to Current, which creates a route through routing tables from one point (the BSP) to another point (Current). Then a route is created (an entry in a routing table) in anticipation of the current node being used to discover nodes attached to the current node. When that discovery takes place, the entry in the routing table is updated. Finally the default link of the current is read and the route to BSP is set to the default link.

Finally, referring to FIG. 4E, node 2 discovers the last undiscovered link 103[3]. When the token from node 3 is read, since the token is 3 and not the default token of 0, the token is left unchanged.

Note that a node only gets its routing tables programmed when its turn comes up to be used to ‘discover’ its neighbors. Until then it is left in default routing mode (this is needed so that the ‘default link register’ can be used to determine which link number on the far end is connected to the near side link currently being examined. The reference to (Current, Selected Link, Default_link, Token) is to an entry that is to be added to the data table that gets built up of all discovered links in the system. The data table (which is initially empty) includes a set of four numbers. One such entry gets created per discovered link. The table below illustrates the table of discovered links after discovery is finished on FIG. 4E:

TABLE 0

| Current | Selected Link | Default Link | Token |
|---|---|---|---|
| N0 | L1 | L0 | N1 |
| N0 | L2 | L0 | N2 |
| N1 | L1 | L1 | N3 |
| N2 | L1 | L0 | N3 |

In the table, L1 is the actual link number for the link in Node 0 (N0), and L0 is the link number for the same link in Node 1 (N1). Notice how all links from Node 0 (that were not already in the list) come first, followed by all links leaving N1 (that were not already in the list), followed by all links from N2. That is a direct result of the breadth-first search. This table is later converted into the adjacency matrix. FIG. 4E also shows the routing tables loaded into the nodes as a result of the discovery process. As can be seen from the routing tables, after the discovery is finished the BSP (Node 0) can talk to all nodes, and all nodes can talk to the BSP, but not all nodes can talk to teach other. For example, no traffic will be seen on the link between N2 and N3). Note that the * in the tables indicates entries left over from intermediate steps of the discovery process and will not actually be used and a blank indicates that no entry is made in the routing table.

With this initialization process just described, the initial routing tables are built and loaded into the various nodes allowing the communication in the fabric. At this point, the routing tables have discovered all the nodes but the routing tables established are not necessarily efficient. Further, not only are the routing tables potentially inefficient, but communication may be limited between nodes, although the BSP is able to communicate with any node.

Thus, as explained above, the system discovers the fabric, generates routing tables based on the discovered fabric, and loads the routing tables (with limited capability) based on the discovered fabric into the nodes.

In order to provide high-performance deadlock-free routing tables, an embodiment of the invention stores routing tables for several topologies along with the system initialization code. The discovered topology is then compared against the topologies in the database to locate the appropriate routing tables. In an embodiment the stored topologies yield the node adjacency matrix and abstract routing between nodes as described further herein.

In an embodiment, in order to reduce the effort on the part of the porting engineer, reduce the size of the database, and improve the ability of a single BIOS to support multiple topologies, the database stores abstract topologies instead of logical topologies. An abstract topology only shows the underlying structure of the topology; it omits the node and link numbers. After a match is found between the discovered topology and one of the stored abstract routing tables, the matching abstract routing table is manipulated to correspond to the logical topology that was discovered earlier by including node and link numbers from the discovered topology.

A coherent communication fabric (e.g., formed of HyperTransport links) can be visualized as an undirected graph where the processor nodes are the vertices, and the links are the edges. An abstract topology is one where the nodes and edges are not labeled (in other words, the connections between nodes are shown, but node and link numbers have not been assigned). The discovered topology can be described as a graph where the node and link numbers are known. Topologies are isomorphic if they have the same underlying structure. For example, systems 500, 501, and 502 that have 8P ladder topologies, such as shown in FIG. 5A, are isomorphic to each other because they share the same underlying structure even if they number their nodes differently and/or use a different assignment of communication links to build the fabric. An 8P twisted ladder system, such as shown in FIG. 5B, is not isomorphic to an 8P ladder system because the underlying structure is different.

Since the link numbers have no impact on the underlying structure, it is reasonable to completely ignore link numbers when testing if two graphs are isomorphic. One approach to testing isomorphism is to use an adjacency matrix. An adjacent matrix is an N×N matrix (where N is the number of nodes) that shows when two nodes are adjacent (directly connected) to each other. If node A is directly connected to node B, then adj[i][j]=1, otherwise adj[i][j]=0. The case where two or more links connect the same two nodes together can be ignored for now. The explanation of how this case is dealt with is given later herein. Table 1 below illustrates an adjacency matrix for the graph shown in FIG. 5A. In Table 1, a 1 indicates adjacency and a 0 indicates that it is not adjacent. The node is considered to be adjacent to itself.

TABLE 1

| | A | B | C | D | E | F | G | H |
|---|---|---|---|---|---|---|---|---|
| A | 1 | 1 | 1 | 0 | 0 | 0 | 0 | 0 |
| B | 1 | 1 | 0 | 1 | 0 | 0 | 0 | 0 |
| C | 1 | 0 | 1 | 1 | 1 | 0 | 0 | 0 |
| D | 0 | 1 | 1 | 1 | 0 | 1 | 0 | 0 |
| E | 0 | 0 | 1 | 0 | 1 | 1 | 1 | 0 |
| F | 0 | 0 | 0 | 1 | 1 | 1 | 0 | 1 |
| G | 0 | 0 | 0 | 0 | 1 | 0 | 1 | 1 |
| H | 0 | 0 | 0 | 0 | 0 | 1 | 1 | 1 |

If the adjacency matrix for one graph can be manipulated to match another graph by renumbering the nodes, then the two graphs are isomorphic to each other. One way to renumber the nodes is to use a permutation which is an array of length N (where N is the number of nodes) that contains the numbers 0 . . . N−1. The permutation provides the mapping from the original node numbers to the new node numbers, for example, if perm[2]=5, then the node that was 2 has become node 5. To determine if two graphs are isomorphic to each other simply generate every permutation of length N and then check to see if graph 1_adj [perm[i]] [perm[j]]==graph2[i][j] for every value of i and j in the range from O . . . N. If a permutation is found then the graphs are isomorphic, if no permutation satisfies that property then the graphs are not isomorphic. The total number of permutations is N!. Thus, for example, with an 8-node system there are 40,320 permutations.

A few techniques outlined below can be used to further optimize the process. First, if two graphs do not share the same number of vertices, then they are obviously not isomorphic. For example, a system with 2 nodes cannot have the same underlying structure as a system with 8 nodes. Also, if the total number of edges in the two graphs do not match, then it is impossible for the two graphs to be isomorphic. These two rules can be used to quickly reject entries in the database of abstract topologies.

The degree of a vertex is determined by counting the number of edges that connect to that vertex. Only permutations that map vertices onto other vertices of the same degree will yield isomorphism (e.g., if a node has 3 coherent links it clearly can't map onto a node that only has 2 coherent links). This rule can be used to significantly reduce the number of permutations generated and tested.

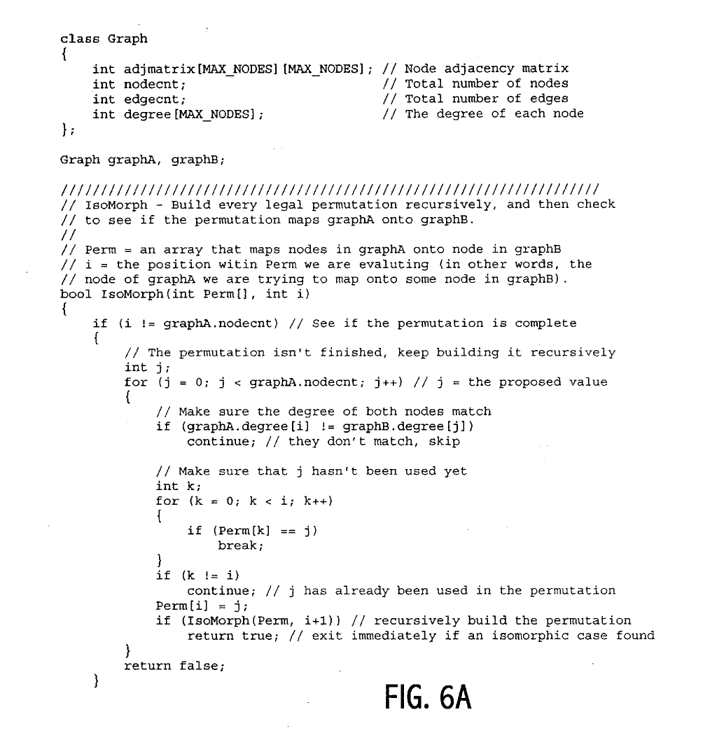

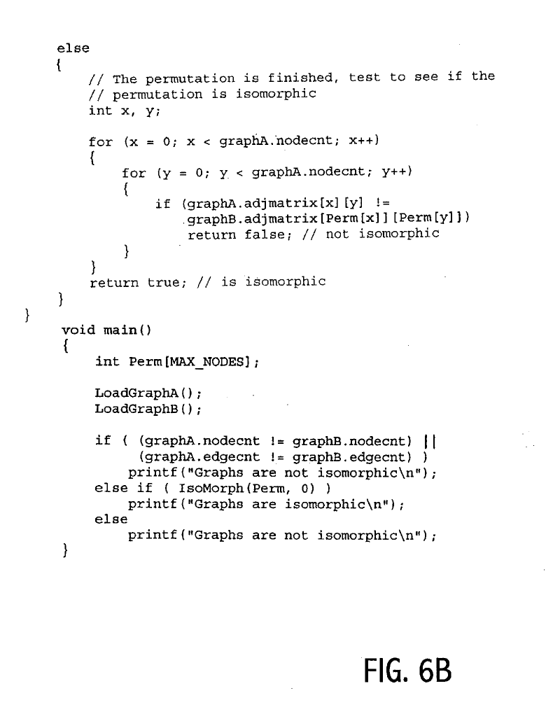

FIGS. 6A and 6B illustrate exemplary code that can determine if two graphs are isomorphic utilizing permutations and comparison of adjacency matrixes. Note that one output that should be provided from a graph isomorphism algorithm is a mapping between the abstract node numbers (e.g., A, B, C, D) and node numbers actually assigned during discovery (e.g., 0, 1, 2, 3).

If two nodes are connected by more than one link, the additional links can be ignored. The extra links can be dealt with as a post processing step. For example the extra links could be used to split traffic based upon its class (request, response, probe), or a traffic distribution feature can be used.

The stored abstract routing tables can be stored in a database. In embodiments where space is scarce resource, the database should be implemented to have a structure so that the entries in the database are as compact as possible. In an exemplary embodiment, the fields include a 1 byte node count (NodeCnt) indicating the number of nodes in the topology, e.g., range 1 . . . 8. Note that a 1 node system may be handled as a special case. A second database entry is routing tables (RTables) with each table being an N×N matrix (NodeCnt×NodeCnt), with each entry in the matrix being two bytes. The routing tables are in the form Tables[SrcNode][DestNode][2]. The first byte is a bit field (e.g., 10011101) indicating which nodes should receive probes (also referred to as broadcasts). The second byte contains two sub-fields indicating the node to which the request or response should be sent. Unlike the processors actual routing tables that indicate which link numbers to use, these routing tables indicate the node to which the data should be forwarded. If a node A is forwarding data to node B, and it does it through node B, that implies that node A is directly connected to node B. Otherwise, if node A forwards data to node D through node C, then it is safe to assume that A and D are not directly connected. That can be used as a basis for the adjacency matrix. Note that the size of a database entry is 2*N*N+1 bytes. A database entry exists for each stored topography. An exemplary data base entry is shown in Table 2 below for the graph shown in FIG. 1B. The bit field is assumed to be a four bit field for this example. The request and response nodes are identified by letter. The routing is for the row. That is row A, column B is routing from A to B. Thus, the rows represent the node trying to process the packet, and the column represents the final destination of the packet. Note that in Table 2, the routing for requests and responses is the same.

TABLE 2
(4 nodes)

| | A | B | C | D |
|---|---|---|---|---|
| A | 0110, [X] [X] | 0000, [B] [B] | 0010, [C] [C] | 0000, [C] [C] |
| B | 0000, [A] [A] | 1001, [X] [X] | 0000, [D] [D] | 0001, [D] [D] |
| C | 1000, [A] [A] | 0000, [A] [A] | 1001, [X] [X] | 0000, [D] [D] |
| D | 0000, [B] [B] | 0100, [B] [B] | 0000, [C] [C] | 0110, [X] [X] |

Note that an X is a “don't care” and indicates that it is implied that a node can talk to itself, so the entry in the table can be unused. Note that the bitfield in Table 2 represents nodes D,C,B,A in that order. Table 3 provides another way to present the information in Table 2 by providing an example of a routing table in which the broadcast bitfields show by letter the nodes to which broadcasts should be sent. If no node letter is specified, no packet is sent to that node.

TABLE 3

| | A | B | C | D |
|---|---|---|---|---|
| A: | .CB., [X][X] | ...., [B][B] | ..B., [C][C] | ...., [C][C] |
| B: | ...., [A][A] | D..A, [X][X] | ...., [D][D] | ...A, [D][D] |
| C: | D..., [A][A] | ...., [A][A] | D..A, [X][X] | ...., [D][D] |
| D: | ...., [B][B] | .C.., [B][B] | ...., [C][C] | .CB., [X][X] |

An example of the use of the bit fields for a probe (or broadcast) is as follows. In an embodiment, broadcasts are routed based on the source, not the destination. So for example, with reference to Table 3 and FIG. 1B, assume that node A is sending a broadcast packet. The steps in the broadcast are as follows:

Step 1: The quadrant defined by row A (the current node), column A (the ‘Source’ of the broadcast)==. CB. So the broadcast is sent to both nodes B and C. (Note that steps 2a and 2b occur concurrently but independently)
Step 2a: Row B (the current node), Column A (the ‘Source’ of the broadcast)== . . . , so the packet is not forwarded since the bitfield is blank.
Step 2b: Row C (the current node), Column A (the ‘Source’ of the broadcast)==D . . . , so the packet is forwarded to node D.
Step 3: Row D (the current node), Column A (the ‘Source’ of the broadcast)== . . . , so the packet is not forwarded. At this point in time all nodes (A-D) have seen the packet.

In an embodiment, the routing table is decompressed in memory into the adjacency matrix for use by the graph isomorphism check. Another and perhaps better approach, is to utilize a subroutine that runs in O(1) (the Big O notation indicating the time complexity of the algorithm) that would return if NodeA was adjacent to NodeB based upon the tables. That would consume less data storage. Note that to get reasonable performance out of the graph isomorphism checking algorithm, I-cache may need to be enabled in some embodiments.

Once a stored abstract topology has been identified as isomorphic to the discovered topology, the stored abstract topology is modified to include the discovered node. At this stage three key bits of information are available. First is the table of discovered links (Current, selected link, Default_link, Token) described above. Second is the abstract routing table from the database that is known to be isomorphic to the discovered topology. Finally, the graph isomorphism algorithm provided the mapping between the abstract node numbers (say A,B,C,D) and node numbers that were assigned during discovery. The actual routing tables that the nodes use are created by taking the abstract routing table and converting into the format used by the nodes. The routing table must be rearranged using the abstract to actual node mappings. Further, the abstract representation shown, e.g., in Table 2, (Node A talks to Node B) is replaced with Node 0 uses its link 1 to send a packet to Node 1.

After the stored abstract topology is modified to include the link numbers and node numbers of the discovered topology, the modified routing tables computed from the abstract topology and the discovered topology are loaded into the fabric starting at the highest node number (last discovered) working back towards the boot strap processor (BSP). Loading in that order ensures that the fabric will not lose connectivity during the table load process.

Referring now to Tables 0 and 2, and FIG. 4F, assume that the graph isomorphism algorithm decided that the abstract topology mapped onto the discovered topology this way (A=N0, B=N1, C=N2, D=N3). Then using that mapping, along with the abstract routing tables, the routing table shown in Table 4 is produced:

TABLE 4

| | N0 | N1 | N2 | N3 |
|---|---|---|---|---|
| N0 | self | L1 | L2 | L2 |
| N1 | L0 | Self | L1 | L1 |
| N2 | L0 | L0 | self | L1 |
| N3 | L1 | L1 | L0 | self |

Note that the columns represent the destination and the row is the node processing the packet. Also, Table 4 only shows the requests/responses since they are the same for this particular example. This table is then copied into the actual nodes as the routing tables as shown in FIG. 4F. An example of how the routes are actually used is as follows. Assume N0 has a packet for N3. N0 looks at its routing table and sees that it must route packets for N3 to link L2. N2 receives the packet from N0. N2 looks at its routing table and sees that it must route packets for N3 over link L1. N3 receives the packet from N2 and consumes the packet.

The probe routing is shown as Table 5. Note again that the column represents the source of the broadcast and the row is the node processing the broadcast. Please note that instead of encoding a link to use, a bitfield of links is used, so that the node can send the same packet out of multiple links at the same time:

TABLE 5

| | N0 | N1 | N2 | N3 |
|---|---|---|---|---|
| N0 | L2L1 | none | L1 | none |
| N1 | none | L1L0 | none | L0 |
| N2 | L1 | none | L1L0 | none |
| N3 | none | L0 | none | L1L0 |

So if N3 sends a broadcast the following happens: N3 generates a broadcast packet. N3 looks at its routing table and sees that it must send the packet on both its L1 and L0 links. A copy of the packet arrives at Node2 and at Node1. Node2 receives the packet from Node3 and looks at its routing table and does nothing. Node1 receives the packet from Node3, looks at its routing table, and sends the packet out L0. Node0 receives the packet from Node1 and looks at its routing table and does nothing. The packet has been broadcast to all nodes.

When loading routing tables into the nodes, loading starting at the highest node number helps ensure that the fabric will not lose connectivity during the table load process. The advantage of that approach can be seen by considering the following. Assume that the fabric is composed of HT links. To configure the HT fabric consideration is given to both (A) the requests from the BSP to any node, and (B) the responses from any node to the BSP. Only the BSP will be running code (therefore A is true), and since no other node besides the BSP is generating requests, there will be no responses to requests other than those of the BSP (therefore B is true).

The discovery algorithm results in the fabric being configured in such a way that requests follow a spanning tree from the BSP to their target, and responses back to the BSP follow the reverse path. The node numbers are assigned in the order the nodes are discovered, so nodes further from the BSP have a higher number than those closer to the BSP. Since the requests and responses are routed independently by the hardware, the two cases can be considered separately (a problem routing a request will not result in a problem routing a response, or vice versa).

First consider requests. Requests follow the spanning tree from the BSP to their targets. The leaf nodes of the spanning tree can be modified without risk because their routing registers would not be used by the BSP to reach any of the other nodes in the system. If the routing table load process starts at the highest node number it is guaranteed to be reconfiguring a leaf node. If reconfiguring nodes continue in descending node order one will eventually hit a non-leaf node. As long as one does not go back and touch a higher numbered node, it is safe to modify the non-leaf node, since the spanning tree to the lower number nodes is still intact. The process continues until the BSP is reached, and the BSP routing tables are modified. Once the BSP's request routing tables are modified it is then safe to access any node in the system because the request routing tables are now fully initialized.

Now consider responses. After each configuration access request to a node, the node sends a TgtDone or RdResponse packet. The TgtDone is a response from the target indicating the target received the packet. The RdResponse is a packet including data in response to a read request. The discovery algorithm follows the spanning tree in reverse order back to the BSP, and therefore every node will know a response path back to the BSP. That response path will always route traffic to a lower numbered node. Loading the response routing tables also starts with the highest numbered node. Keep in mind that the response routings that the loading process is trying to load are known to be legal since they are based on the discovered topology and the matching stored abstract topology. The only concern is that something illegal is not done while trying to load the routing tables into each node, for example, creating a cycle that would isolate a node inadvertently. Since the current node is the highest numbered node there is no choice but for the new tables to route the response to a lower numbered node. Since the lower numbered nodes already have a path back to the BSP there is no problem. When loading the second to the highest node's routing tables the new tables again must route to the higher numbered node, or to a lower numbered node. If the lower numbered node is used, then there is no problem since it already has a path to the BSP. If the higher numbered node is used, the higher numbered node must use a node other than second highest node to route the traffic back to the BSP (if this did create a cycle, that would mean that the new routing tables had a cycle, and that would be illegal). This means that the highest node must be routing traffic to the BSP via a node number less than the second highest node number, and that node would then already have a path back to the BSP via the intact reverse spanning tree. This recursive process illustrates the basic point: If loading the response tables starts at the highest node number and continues down to the BSP, then every intermediate configuration will have the property that responses will be bounced around the higher node numbers (but will not result in a live lock because the higher node numbers have legitimate tables), until the packet reaches a lower node number which will then route the packet via the reverse spanning tree to the BSP.

Note that since the process of loading request tables and response tables must follow the same order (Highest Node−>0), and since the request and response tables don't adversely impact each other, it is possible to load them both at the same time. The following summarizes the loading process:

```
for (i = DiscoveredNodes; i <= 0; i−−)
{
  for (j = 0; j < DiscoveredNodes; j++)
    load routing table[i][j];
}
```

When building and programming the routing tables “extra-links” between two CPUs can be ignored. These links may occur as a result of dual-link or triple-link topology in which two or three links connect two devices. In topologies with extra links, after the basic coherent link enumeration has taken place, the system can then take advantage of the “extra-links” in a final step, e.g., by distributing traffic between the extra links.

The methods described above may be embodied in a computer-readable medium for execution by a computer system. The computer readable media may be computer readable storage media permanently, removably, or remotely coupled to system 100 or another system. The computer readable storage media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc. The computer readable media may also include data transmission media including permanent and intermittent computer networks, point-to-point telecommunication equipment, carrier wave transmission media, the Internet, just to name a few. Other new and various types of computer-readable media may be used to store and/or transmit the software modules discussed herein.

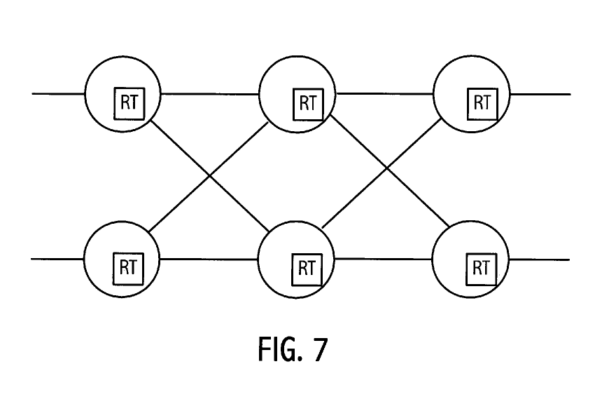

While the application has described use of stored abstract topologies with respect to multi-processor systems, particularly those systems having processors connected by HyperTransport links, the approach described herein is applicable to communications more generally. In particular, the approach may be used in such applications as cluster innerconnects, processor/GPU/FPGA interconnects, and high speed data switching equipment. Thus, rather than processing nodes, the nodes may be switching, communication, storage, or other network connected nodes, used, e.g., in a network switch, such as the switch shown in FIG. 7.

The description of the invention set forth herein is illustrative, and is not intended to limit the scope of the invention as set forth in the following claims. Other variations and modifications of the embodiments disclosed herein may be made based on the description set forth herein, without departing from the scope and spirit of the invention as set forth in the following claims.

What is claimed is:

1. A method of initializing a communication system having a plurality of nodes and a plurality of links connecting the nodes, the method comprising:
determining a match between a discovered topology in the communication system and one of a plurality of stored abstract topologies;
computing routing tables for each of the nodes using the one of the plurality of stored abstract topologies and node numbers of the discovered topology; and
loading respective ones of the computed routing tables into the nodes.

2. The method as recited in claim 1, further comprising:
loading the computed routing tables starting at leaf nodes, working back towards a root node.

3. The method as recited in claim 2, wherein loading the computed routing tables starting at leaf nodes, and working back towards the root node comprises starting loading routing tables at the highest node number and working back towards the root node.

4. The method as recited in claim 1, further comprising discovering the topology of the communications network.

5. The method as recited in claim 4, wherein discovering the topology further comprises:
performing a breadth-first discovery of a communication fabric starting from a root node; and
assigning ascending node numbers as each node is discovered.

6. The method as recited in claim 1, further comprising:
storing a database of abstract topologies that yields a node adjacency matrix and abstract routing between nodes.

7. The method as recited in claim 1, further comprising:
using a graph isomorphism algorithm to determine the match between the discovered topology and one of the stored abstract topologies.

8. The method as recited in claim 1, wherein determining the match comprises comparing an adjacency matrix associated with the discovered topology with an adjacency matrix associated with the stored abstract topologies.

9. A communication system comprising:
a plurality of nodes;
a plurality of communication links coupling the nodes;
a storage storing a plurality of abstract topologies of communication links; and
wherein the communication system is operable to determine a match between a discovered topology in the communication system and one of the stored abstract topologies.

10. The communication system as recited in claim 9 further operable to compute routing tables for each of the nodes using the one of the stored abstract topologies and node numbers in the discovered topology

11. The communication system as recited in claim 10, further operable to load respective ones of the computed routing tables into the nodes starting at leaf nodes, working back towards a root node.

12. The communication system as recited in claim 9, wherein the abstract topologies are stored as a database that yields a node adjacency matrix and provides abstract routing between nodes.

13. The communication system as recited in claim 9, wherein the communication system is operable to use a graph isomorphism algorithm to determine the match between the discovered topology and one of the stored abstract topologies.

14. The communication system as recited in claim 9 wherein the communication system is coupling processing nodes in a computer system.

15. The communication system as recited in claim 9 wherein the communication system is coupling nodes in a switch.

16. A computer program product encoded in one or more machine-readable media comprising:
initialization code for initializing a communication system having a plurality of nodes and a plurality of links connecting the nodes, the initialization code executable to,
determine a match between a discovered topology in the communication system and one of a plurality of stored abstract topologies; and
compute routing tables for each of the nodes using the one of the plurality of stored abstract topologies and the discovered topology.

17. The computer program product as recited in claim 16, wherein the initialization code is further executable to utilize the node numbers of the discovered topology in computing the routing tables.

18. The computer program product as recited in claim 16, wherein the initialization code is further executable to load the computed routing tables into the nodes starting at leaf nodes, working back towards a root node.

19. The computer program product as recited in claim 16, wherein the initialization code is further executable to determine the match between the discovered topology and one of the stored abstract topologies using a graph isomorphism algorithm.

20. The computer program product as recited in claim 16, wherein the initialization code is further executable to compare a first adjacency matrix associated with the discovered topology with a second adjacency matrix associated with the stored abstract topologies to determine the match.

21. The computer program product of claim 16, encoded in at least one computer readable storage medium.

22. The computer program product of claim 16, encoded in data transmission media.
